(19) United States
(12) Patent Application Publication
(10) Pub. No.: US 2010/0253247 A1
(43) Pub. Date: Oct. 7, 2010

(54) ELECTRONIC CANDLE

(75) Inventors: WEN SHU, Shenzhen City (CN); CHING-CHIH LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/503,850

(22) Filed: Jul. 16, 2009

(30) Foreign Application Priority Data
Apr. 1, 2009 (CN) 200910301280.9

(51) Int. Cl. H05B 37/02

(52) U.S. Cl. 315/362

(57) ABSTRACT

An electronic candle includes a main body, a lamp unit fixed on the main body; and a detecting system received in the main body. The main body includes a top plate. The top plate defines a plurality of air ducts communicating with the inside of the main body. The detecting system includes a temperature detector configured for detecting an air temperature traveling through the air ducts from the lamp unit of the inside of the main body and outputting the temperature as an analog electrical signal, an analog-to-digital convertor configured for converting analog electrical signal into a digital signal, a storage unit configured for buffering the digital signal and storing a predetermined temperature value, a switching unit continuing or discontinuing the power to the lamp unit; and a processor for comparing the digital signal with the predetermined temperature and instructing the switching unit to turn off the lamp unit.

### BACKGROUND

1. Technical Field

The present disclosure relates to an electronic candle.

2. Description of Related Art

Electronic candles are widely used for decorative lighting. Most current electronic candles are not interactive and will not simulate a real candle being blown out, and most current electronic candles need to be manually turned on/off.

What is needed, therefore, is an electronic candle to overcome the above-mentioned problems.

### BRIEF DESCRIPTION OF THE DRAWINGS

FIG. 1 is a schematic view of an electronic candle, according to an exemplary embodiment of the disclosure.

FIG. 2 is a functional block diagram of a detecting system of the electronic candle of FIG. 1.

### DETAILED DESCRIPTION

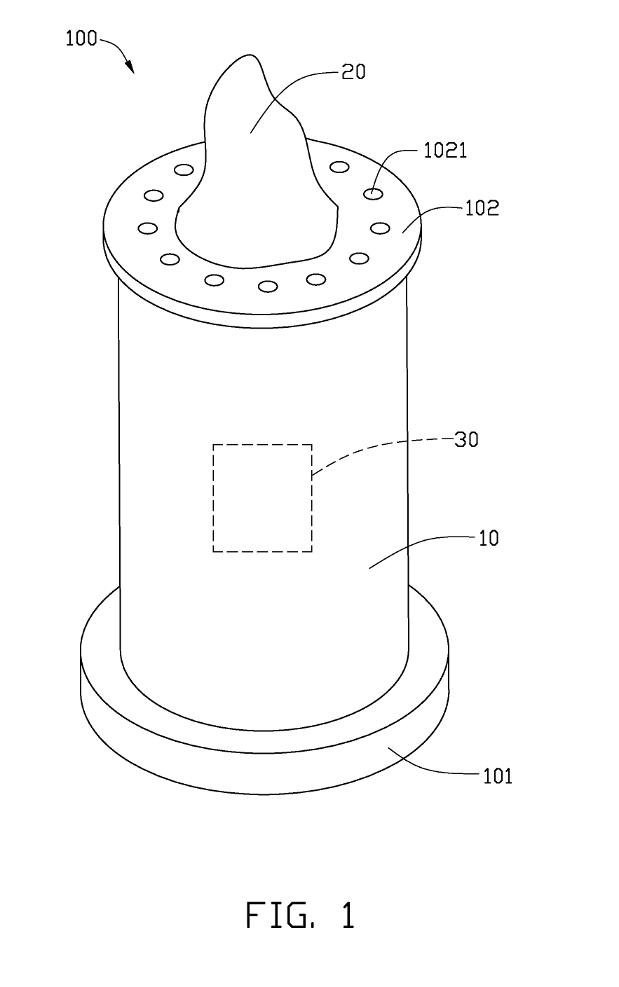

Referring to FIG. 1, an electronic candle 100, according to an exemplary embodiment, is shown. The electronic candle 100 includes a hollow cylindrical main body 10, a lamp unit 20 fixed on the top of the main body 10, and a detecting system 30 received within the main body 10.

The main body 10 includes a base 101 and a top plate 102 on the side of the main body 10 opposite to the base 101. The base 101 is configured for stably setting the main body 10 on other object, such as a table (not shown). The top plate 102 of the main body 10 defines a number of air ducts 1021. Each of the air ducts 1021 communicates with the inside of the main body 10.

The lamp unit 20 is disposed on the top plate 102 of the main body 10, and can be a light emitting diode (LED) lamp or any other electrical lamp.

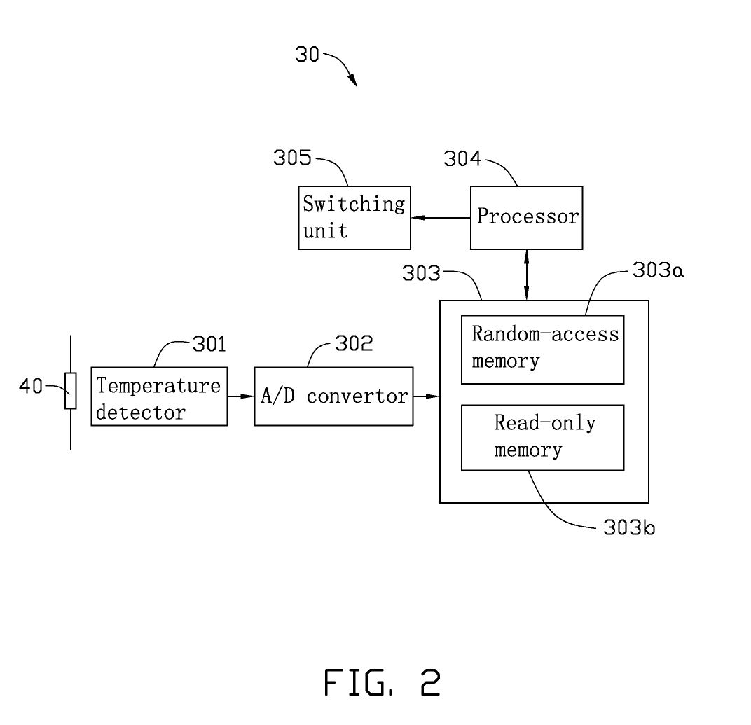

Referring to FIG. 2, the detecting system 30 includes a temperature detector 301, an analog-to-digital (A/D) convertor 302 connected to the temperature detector 301, a storage unit 303 connected to the A/D convertor 302, a processor 304 connected to storage unit 303, and a switching unit 305 connected to the processor 304.

The temperature detector 301 is configured for detecting an air temperature traveling through the air ducts 1021 from the lamp unit 20, and outputting the temperature as an analog electrical signal.

The A/D convertor 302 is configured for converting the analog electrical signal into a digital signal (bits of binary digits).

The storage unit 303 includes a random-access memory 303a and a read-only memory 303b. The random-access memory 303a is configured for temporarily storing the digital signal. The read-only memory 303b is configured for storing a predetermined temperature value.

The processor 304 is configured for comparing the digital signal (i.e., the detected temperature) and the predetermined temperature and instructing the switching unit 305 to continue or discontinue the power to the lamp unit 20, based on the comparison. In detail, the processor 304 first reads the digital signal and the predetermined temperature, then compares the digital signal and the predetermined temperature information, and then controls the switching unit 305 to continue or discontinue the power to the lamp unit 20.

The switching unit 305 is electrically connected to the lamp unit 20 for continuing or discontinuing the power to the lamp unit 20.

The electronic candle 100 further includes a thermal resistor 40 positioned near the temperature detector 301. The thermal resistor 40 is configured for providing heat around the temperature detector 301 to maintain the air temperature within a predetermined temperature range. Commonly, the air temperature around the temperature detector 301 is higher than outside of the main body 10.

In operation, the electronic candle 100 can automatically turn off the lamp unit 20 when the lamp unit 20 is subjected to a strong wind such as the act of blowing on the lamp unit 20. In detail, when a person blows on the lamp unit 20, the air around the lamp unit 20 enters the main body 10 via the air ducts 1021. This movement of air displaces the hot air around the temperature detector 301 with cooler air from outside the main body 10 and the temperature detector 301 detects this lower temperature. The processor 304 controls the switching unit 3054 to turn off the lamp unit 20 if the digital signal representing the air temperature is lower than the predetermined temperature.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic candle comprising:
a hollow cylindrical main body comprising a top plate, the top plate defining a plurality of air ducts communicating with the inside of the main body;
a lamp unit fixed on the top plate; and
a detecting system received in the main body, the detecting system comprising:
a temperature detector configured for detecting air temperature traveling through the air ducts from the lamp unit and outputting the temperature as an analog electrical signal;
an analog-to-digital (A/D) convertor configured for converting analog electrical signal into a digital signal;
a storage unit configured for buffering the digital signal and storing a predetermined temperature value;
a switching unit for continuing or discontinuing the power to the lamp unit; and
a processor for comparing the digital signal with the predetermined temperature and instructing the switching unit to turn off the lamp unit.

2. The electronic candle as claimed in claim 1, wherein the main body comprises a base on a side of the main body opposite the top plate configured for stably setting the main body on other object.

3. The electronic candle as claimed in claim 1, wherein lamp unit is a LED lamp.

4. The electronic candle as claimed in claim 1, wherein the storage unit comprises a random-access memory and a read-only memory, the random-access memory is configured for storing digital signal, and the read-only memory is configured for storing a predetermined temperature value.

5. The electronic candle as claimed in claim 1, wherein the electronic candle comprises a thermal resistor positioned near the temperature detector and configured for providing heat around the temperature detector to maintain the air temperature within a predetermined temperature range.
